(19) United States
(12) Patent Application Publication
(10) Pub. No.: US 2026/0031906 A1
(43) Pub. Date: Jan. 29, 2026

(54) SPACE LASER COMMUNICATION DEVICE AND OPERATING METHOD THEREOF

(71) Applicant: ELECTRONICS AND TELECOMMUNICATIONS RESEARCH INSTITUTE, Daejeon (KR)

(72) Inventors: Si Woong PARK, Daejeon (KR); Hyoungjun PARK, Daejeon (KR); CHAN IL YEO, Daejeon (KR); Young Soon HEO, Daejeon (KR)

(73) Assignee: ELECTRONICS AND TELECOMMUNICATIONS RESEARCH INSTITUTE, Daejeon (KR)

(21) Appl. No.: 19/023,139

(22) Filed: Jan. 15, 2025

(30) Foreign Application Priority Data
Jul. 29, 2024 (KR) 10-2024-0100306

(51) Int. Cl. H04B 10/112; H04B 10/29; H04B 10/50

(52) U.S. Cl. CPC H04B 10/1123; H04B 10/29; H04B 10/503

(57) ABSTRACT

An operating method of a space laser communication device is provided. The operating method includes a step of performing optical alignment so that one of optical systems performs optical multiple input multiple output (MIMO)-based full-duplex communication with another space laser communication device, based on motion control by a motion control device and a step of performing optical alignment so that the other optical system of the optical systems performs optical MIMO-based relay communication with another space laser communication device, based on motion control by the motion control device.

### CROSS-REFERENCE TO RELATED APPLICATIONS

This application claims the benefit of the Korean Patent Application No. 10-2024-0100306 filed on Jul. 29, 2024, which is hereby incorporated by reference as if fully set forth herein.

### BACKGROUND

### Field of the Invention

The present invention relates to a space laser communication device and an operating method thereof, and more particularly, to a space laser communication device and an operating method thereof, which may construct space Internet and may improve the scalability, efficiency, and reliability of space communication.

### Discussion of the Related Art

A conventional radio frequency (RF)-based satellite communication system generally used in space communication has limitations in communication distance and bandwidth and size, weight, and power consumption (SWaP) enabling installation in satellite. In a method for overcoming such limitations, interest in satellite communication technology using laser optics is increasing.

Satellite communication technology using laser optics is referred to as various terms such as optical wireless communication (OWC), free space optical communications (FSOC), space laser communication (SLC), and deep space optical communication (DSOC).

Space laser communication has a divergence angle which is far narrower than RF-based communication technology, and thus, may be configured to have a small antenna size compared to RF-based communication technology. Therefore, the efficiency of SWaP is high. Also, space laser communication uses a laser beam having straightness and a narrow divergence angle, and thus, is capable of long-distance transmission and massive transmission based on a wide bandwidth. Such advantages of space laser communication are more remarkable in an environment which is hardly affected by air like space.

Most space laser communication systems are operated based on single-input single-output (SISO). SISO performs transmission and reception by using one antenna, and thus, has a limitation in transmission power and reception sensitivity. Therefore, in a case where a network is constructed in various environments such as space-to-space (S2S), space-to-air (S2A), space-to-ground (S2G), and space-to-maritime (S2M), SISO has limitations in scalability, efficiency, and reliability.

To solve such limitations, communication technology for accomplishing long-distance and massive transmission based on higher reception sensitivity through a plurality of antennas and increasing the scalability, efficiency, and reliability of network configuration is required. Also, it is required to efficiently increase the economic and efficiency of space laser communication technology even without introduction of an additional system, based on the communication technology.

### SUMMARY

An aspect of the present disclosure is directed to providing a space laser communication device and an operating method thereof, which are based on optical multiple input multiple output (MIMO)-relay so as to enhance the scalability, efficiency, and reliability of a network in full-duplex communication between satellites.

By accomplishing such an object, a limited satellite onboard environment may be efficiently improved, channel expansion may be easily supported without additional system introduction, and a MIMO link based on line of sight (LoS) alignment between devices may be established and maintained. A space laser communication device and an operating method thereof according to an embodiment of the present invention may simultaneously perform full-duplex data communication and a tracking beacon function, based on a space laser communication system device structure based on a common light path requiring no separate beacon beam subsystem generally used in LoS alignment (or LoS pointing) between devices. Based on such a structure, the space laser communication device and the operating method thereof according to an embodiment of the present invention may enable the number of electrical/optical elements to be reduced, and thus, may increase size, weight, and power consumption (SWaP), may optimally support tracking between devices, and may continuously form a MIMO link.

To achieve these and other advantages and in accordance with the purpose of the invention, as embodied and broadly described herein, there is provided an operating method of a space laser communication device including at least two optical systems and a motion control device controlling motions of the at least two optical systems, the operating method including: a step of performing optical alignment so that one of the at least two optical systems performs optical multiple input multiple output (MIMO)-based full-duplex communication with another space laser communication device, based on motion control by the motion control device; and a step of performing optical alignment so that the other optical system of the at least two optical systems performs optical MIMO-based relay communication with another space laser communication device, based on motion control by the motion control device.

In an embodiment, the step of performing the optical alignment so that the one optical system performs the optical MIMO-based full-duplex communication with the other space laser communication device may include: a step of outputting an optical signal by using a transceiver of the space laser communication device; a step of controlling a pointing ahead angle of the output optical signal by using a fast steering mirror of the space laser communication device; and a step of transmitting the pointing ahead angle-controlled optical signal to the other space laser communication device by using a lens unit of the space laser communication device.

In an embodiment, the operating method may further include a step of performing 5-axis control of an optical fiber connector by using a 5-axis stage device of the space laser communication device to control a divergence angle of the optical signal output from the transceiver, between the step of outputting the optical signal and the step of controlling the pointing ahead angle of the optical signal.

In an embodiment, the step of performing the optical alignment so that the one optical system performs the optical MIMO-based full-duplex communication with the other space laser communication device may include: a step of receiving an optical signal from the other space laser communication device by using a lens unit of the space laser communication device; a step of splitting the received optical signal into a data optical signal and a tracking optical signal by using a beam splitter of the space laser communication device; a step of sensing the tracking optical signal by using a quadrant photodiode of the space laser communication device to check a position of the optical signal; a step of performing the optical alignment by using a fast steering mirror of the space laser communication device, based on the checked position of the optical signal; and a step of receiving the data optical signal having a maximum amount of light by using an avalanche photodiode of the space laser communication device, based on the performed optical alignment.

In another aspect of the present invention, there is provided a space laser communication device including: optical systems; and a motion control device configured to control motions of the optical systems, wherein one of the optical systems may perform optical alignment to perform optical multiple input multiple output (MIMO)-based full-duplex communication with another space laser communication device disposed at a first position, based on motion control by the motion control device, and the other optical system of the optical systems may perform optical MIMO-based relay communication with another space laser communication device disposed at a second position differing from the first position, based on motion control by the motion control device.

In an embodiment, each of the optical systems may include: a transceiver configured to output an optical signal; a fast steering mirror configured to control a pointing ahead angle of the output optical signal; and a lens unit configured to transmit the pointing ahead angle-controlled optical signal to the other space laser communication device.

In an embodiment, the space laser communication device may further include a 5-axis stage device configured to perform 5-axis control of an optical fiber connector to control a divergence angle of the optical signal output from the transceiver.

In an embodiment, each of the optical systems may include: a lens unit of the space laser communication device configured to receive an optical signal from the other space laser communication device; a beam splitter configured to split the received optical signal into a data optical signal and a tracking optical signal; a quadrant photodiode configured to sense the tracking optical signal to check a position of the optical signal; a fast steering mirror configured to perform the optical alignment, based on the checked position of the optical signal; and an avalanche photodiode configured to receive the data optical signal having a maximum amount of light, based on the performed optical alignment.

In an embodiment, the optical systems may include two upper optical systems disposed in an upper side and two lower optical systems disposed in a lower side, the upper optical systems may perform optical MIMO-based full-duplex communication with the other space laser communication device, and the lower optical systems may perform optical MIMO-based relay communication with the other space laser communication device.

In an embodiment, the upper optical systems may rotate and move to face the other space laser communication device, based on control by the motion control device, and the lower optical systems may rotate and move to face the other space laser communication device, based on control by the motion control device.

According to embodiments of the present invention, the optimal maintenance of LoS alignment between artificial satellites or between the ground and a satellite may be compactly performed through a pointing ahead angle (PAA) function based on fast steering mirror (FSM), FSM, and quadrant photodiode (QPD), a response may be quickly performed and signal delay may be effectively compensated for in a dynamic environment, and efficient installation may be performed based on a limited satellite onboard environment.

Accordingly, various configurations and expansions of a satellite communication network may be easily supported even without additional system introduction, and the efficiency of frequency use and link reliability may be considerably improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a conceptual diagram for describing a space laser communication device based on optical multiple input multiple output (MIMO)-relay according to an embodiment of the present invention.

FIG. 2 is a block diagram for describing an internal configuration of a space laser communication device based on optical MIMO-relay according to an embodiment of the present invention.

FIGS. 3 and 4 are layout diagrams of some elements included in the space laser communication device based on optical MIMO-relay of FIG. 2.

FIG. 5 is a diagram for describing an example where pointing ahead angle (PAA) technology based on fast steering mirror (FSM) is applied to a full-duplex space laser communication device based on an optical MIMO scheme according to an embodiment of the present invention.

FIG. 6 is a diagram conceptually illustrating a management and operation of a full-duplex space laser communication device based on a 2×2 optical MIMO-relay scheme according to an embodiment of the present invention.

FIG. 7 is a diagram conceptually illustrating a management and operation of a full-duplex space laser communication device based on a 4×4 optical MIMO-relay scheme according to another embodiment of the present invention.

FIGS. 8 and 9 are diagrams for describing an operating method of a full-duplex space laser communication device based on an optical MIMO-relay scheme according to an embodiment of the present invention.

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts. In the following description, the technical terms are used only for explaining a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

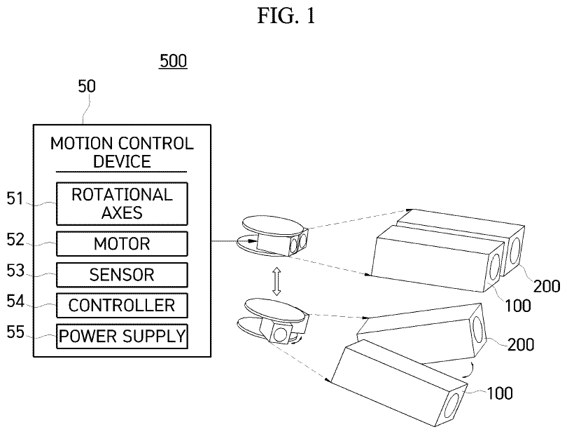

FIG. 1 is a conceptual diagram for describing a space laser communication device 500 based on optical multiple input multiple output (MIMO)-relay according to an embodiment of the present invention.

Referring to FIG. 1, the space laser communication device 500 based on optical MIMO-relay according to an embodiment may include at least two optical systems 100 and 200 which may simultaneously perform transmission and reception and may support a full-duplex scheme which is a bidirectional transmission scheme. Additionally, the space laser communication device 500 may further include a motion control device 50 which controls motions of the optical systems 100 and 200.

To perform an optical MIMO-relay function, the at least two optical systems 100 and 200 may rotate and move in the same direction or different directions, based on control by the motion control device 50.

The motion control device 50 may include, for example, rotational axes 51, a motor 52, a sensor 53, a controller 54, and a power supply 55.

The rotational axes 51 may be configured with, for example, two axes or three axes. Each of the axes may enable a rotational motion and may control rotational motions of the optical systems 100 and 200. In three axes, the rotational axes 51 may include a yaw axis which controls a left-right rotation (a horizontal rotation), a pitch axis which controls an up-down rotation (a vertical rotation), and a roll axis which controls a left-right slope (a horizontal slope). Each axis may be connected to the motor 52.

The motor 52 may control the rotational motions of the optical systems 100 and 200 in real time. The motor 52 may rotate based on sensor data to correct motions of the optical systems 100 and 200.

The sensor 53 may sense and monitor a rotational motion of each axis. The sensor 53 may include, for example, a gyro sensor and an accelerometer. The motor 52, for example, may perform correction needed for motions of the optical systems 100 and 200, based on a measurement value measured by the gyro sensor. The accelerometer may be, for example, a sensor which senses a rectilinear motion and may measure the motions of the optical systems 100 and 200. The motor 52 may perform correction needed for the motions of the optical systems 100 and 200, based on a result measured by the accelerometer.

The controller 54 may be an electronic device which functions as “brain” of the motion control device 50 and may process a measurement value measured by the sensor 53 to control an operation of the motor 52. The controller 54 may include at least one central processing unit (CPU) or at least one memory, or may be implemented with a micro controller unit (MCU) which is configured to include the CPU and the memory.

The power supply 55 may be a battery or an external power device, which supplies power to the motion control device 50. The power supply 55 may supply power needed for the motor 52, the sensor 53, and the controller 54.

The motion control device 50 configured to include the elements 51 to 55 may be referred to as a pointing acquisition and tracking (PAT) for tracking the other device which is disposed apart therefrom by a long distance. In broad viewpoint, the motion control device 50 may control all motions of the optical systems 100 and 200, but in narrow viewpoint, the motion control device 50 may control rotational motions of some elements (for example, a fast steering mirror (FSM) described below) included in each optical system and may thus control optical alignment.

The space laser communication device 500 based on optical MIMO-relay may use, as a light source, a laser having a very narrow linewidth.

The FSM may control a pointing ahead angle (PAA) of a transmitted/received laser, based on motion control by the motion control device 50 (or a PAT system).

The motion control device 50 (or the PAT system) may control precise optical alignment through the control of the FSM and a measurement value of a quadrant photodiode (QPD). Here, the QPD may be implemented as a single chip which is configured to include four photodiodes. The four photodiodes may form a quadrant with respect to a center point. When the quadrant individually senses light, the quadrant may convert the sensed light into an electrical signal. When light is incident on the QPD, a current generated in each quadrant may differ based on a position and intensity of the light. A current generated in each quadrant may be individually measured, and the motion control device 50 may analyze a difference between signals to calculate an accurate position of the light (a position of the other terminal).

In FSM-based PAA technology, because an optical wireless communication link between terminals moving at a high speed should be formed in constructing a space laser communication link between satellites or between the ground and a satellite, FSM-based PAA technology may be technology which predicts a motion of the other terminal, calculates PAA based on a direction and a distance to move instead of a current position, and precisely controls the FSM to transmit a laser, based on the PAA.

A PAT system for precise optical alignment may be driven through FSM-based PAA technology, FSM, and QPD, and simultaneously, massive full-duplex optical wireless transmission of Gbps or more may be performed through fiber coupling of an avalanche photodiode (APD) which supports data communication of Gbps or more.

The space laser communication device 500 based on optical MIMO-relay according to an embodiment may be configured to include the at least two optical systems 100 and 200, and thus, may support at least two transmission/reception paths compared to a conventional space laser communication device based on SISO, and even when one path is blocked or damaged, the space laser communication device 500 may perform data transmission through another path. Accordingly, the reliability and robustness of a system may be enhanced.

Moreover, in the space laser communication device 500 based on optical MIMO-relay according to an embodiment, signals for transmitting data through different paths may be affected by different environments, but an error occurring in a specific path may be corrected through a signal of another path, thereby decreasing a data transmission error rate.

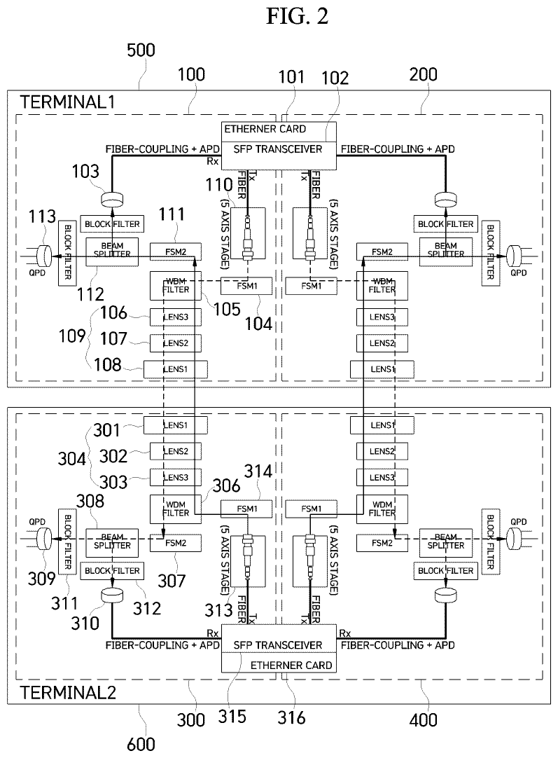

FIG. 2 is a block diagram for describing an internal configuration of a space laser communication device based on optical MIMO-relay according to an embodiment of the present invention.

In FIG. 2, a situation where a terminal 1 and a terminal 2 perform full-duplex space laser communication based on optical MIMO-relay may be assumed. A space laser communication device 500 corresponding to the terminal 1 may include at least two optical systems 100 and 200. A space laser communication device 600 corresponding to the terminal 2 may also include at least two optical systems 300 and 400.

The optical systems 100 to 400 may include the same elements. Hereinafter, for conciseness of description, descriptions of elements included in the optical system 200 of the terminal 1 may be replaced with descriptions of elements included in the optical system 100 of the terminal 1, and descriptions of elements included in the optical system 400 of the terminal 2 may be replaced with descriptions of elements included in the optical system 300 of the terminal 2.

To implement full-duplex space laser communication based on optical MIMO-relay, the number of optical systems should be at least two, and depending on the case, the number of optical systems may more increase.

The space laser communication device 500 of the terminal 1 and the space laser communication device 600 of the terminal 2 may use light sources having different wavelengths. The light source may be a laser. An optical transmitter Tx transmitting a laser may be embedded in a small form factor (SFP) transceiver 102. A fiber-coupled APD 103 supporting data communication of Gbps or more may be an optical receiver Rx and may be embedded in the SFP transceiver 102. The SFP transceiver 102 may be embedded in an optical Ethernet card 101. The optical Ethernet card 101 may support optical wireless-based massive data transmission between two terminals.

A wavelength division multiplexing (WDM) filter 105 separating transmitted or received light into different wavelengths may be equipped in the optical system 100 of the terminal 1. Light output from the transmitter Tx of the SFP transceiver 102 of the terminal 1 may be reflected by an FSM1 104 for PAA control, and reflected light may be again reflected by the WDM filter 105, and then, light again reflected by the WDM filter 105 may be output to a free space through a lens unit 109 including a plurality of lenses 106 to 108. Here, the WDM filter 105 may perform a filtering function of separating transmitted or received light into different wavelengths and may operate based on the principle that the WDM filter 105 reflects the transmitted light and transmits the received light. Also, the lens unit 109 may be referred to as a multiple-output antenna.

Light output by the space laser communication device 500 corresponding to the terminal 1 may pass through a lens unit 304 including a plurality of lenses 301 to 303 included in the optical system 300 of the terminal 2. Here, the lens unit 304 may be referred to as a multiple-input antenna.

Light passing through the lens unit 304 may pass through the WDM filter 306, and light passing through the WDM filter 306 may be reflected by an FSM2 307 for optical alignment and may be incident on the beam splitter 308. Light incident on the beam splitter 308 may be split to the APD 310 which receives data of Gbps or more and the QPD 309 which performs a function of an optical position recognition sensor for performing LoS and tracking on the other terminal 1 by using the beam splitter 308.

A motion control device (or a PAT system) of the terminal 2 may control the FSM2 307 to perform precise optical alignment, based on a measurement value of the QPD 309 used as the optical position recognition sensor, and may perform fiber-coupling through precise optical alignment, based on control by the FSM2 307, and thus, a control loop for inputting a maximum amount of light to the APD 310 may be performed.

Block filters 311 and 312 may be respectively disposed in a front end of the QPD 309 and a front end of the APD 310. The block filters 311 and 312 may filter an undesired wavelength. The block filters 311 and 312 may be added based on a design, or may be removed or replaced with another kind of filter. Examples of the other kind of filter may include a band-stop filter or notch filter, a band-pass filter, a tunable band-pass filter, a high-pass filter, and a low-pass filter. Also, in FIG. 2, the lens unit 109 and 304 each configured with three lenses are illustrated, but are not limited thereto and the lens units 109 and 304 may be configured to include more lenses or less lenses.

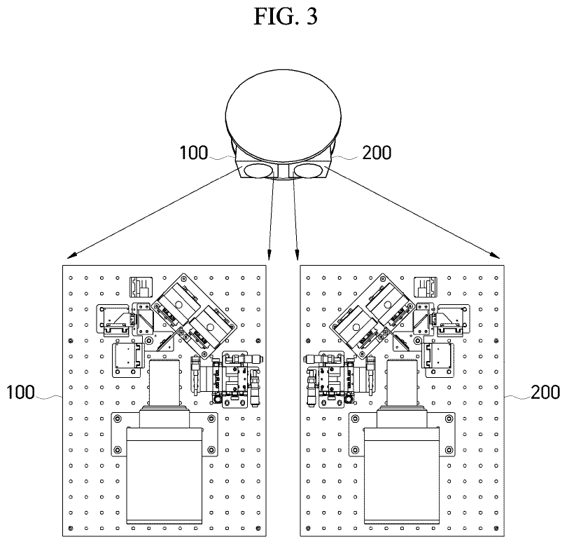

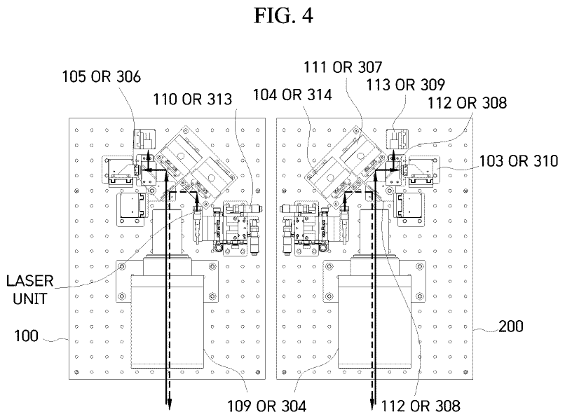

FIGS. 3 and 4 are layout diagrams of some elements included in the space laser communication device based on optical MIMO-relay of FIG. 2.

Referring to FIGS. 3 and 4, a 5-axis stage device 110 or 313 for laser source alignment may perform 5-axis (X, Y, Z, yaw, and pitch) control of an optical fiber connector to align an optical fiber connector, so as to control a divergence angle of a laser beam output from an SFP transceiver (102 of FIG. 2).

The FSM 104 or 314 (FSM1) for PAA may predict a movement position of the other terminal and may quickly and precisely control light output from the optical fiber connector, and thus, may support the smooth formation of an optical wireless link.

The FSM 111 or 307 (FSM2) for optical alignment may transfer, to the beam splitter 112 or 308, light which passes through the WDM filter 105 or 306 through the lens unit 109 or 304 and is incident thereon, and the light may be split to the QPD 113 or 309 for optical alignment and the APD 103 or 310 for communication.

When a beam is disposed at a center of the QPD 113 or 309 for optical alignment, optical alignment should be completed so that the fiber-coupling efficiency of the APD 103 or 310 for communication is the maximum.

The FSM 111 or 307 (FSM2) for optical alignment may be precisely controlled so that light is disposed at a center of the QPD 113 or 309, based on a measurement value of the QPD 113 or 309 for optical alignment, and thus, a maximum amount of light of a laser incident from the other terminal may be incident on the APD 103 or 310 for communication.

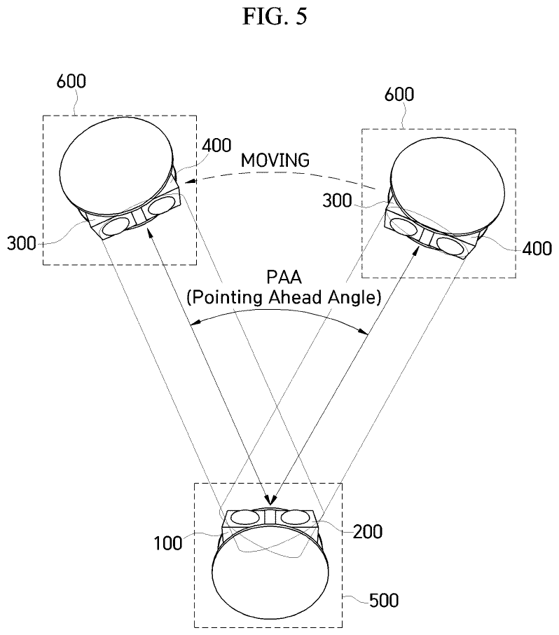

FIG. 5 is a diagram for describing an example where PAA technology based on FSM is applied to a full-duplex space laser communication device based on an optical MIMO scheme according to an embodiment of the present invention.

Referring to FIG. 5, in order to construct and maintain an optical wireless communication link between the ground and a satellite and between satellites with respect to an artificial satellite which quickly move, the FSM 104 or 314 (FSM1) may be driven to support PAA technology. To maintain alignment between the communication device 500 and the communication device 600, PAA technology may predict a future position of the communication device 600 which moves at a high speed, and thus, may previously and continuously adjust a direction of output light to support LoS alignment, so as to maintain LoS construction and the intensity of a received optical signal. Also, based on a movement of a satellite and a state of air, PAA technology may adjust a light output direction through FSM control and may thus support the efficient construction and maintenance of an optical wireless communication link under various conditions. FSM supporting PAA technology may provide a fast response time and may provide precise position control, and thus, may maintain an accurate PAA function and may effectively enhance the stability and quality of the optical wireless communication link.

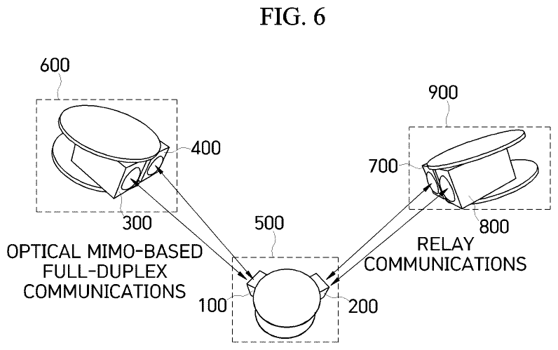

FIG. 6 is a diagram conceptually illustrating a management and operation of a full-duplex space laser communication device based on a 2×2 optical MIMO-relay scheme according to an embodiment of the present invention.

In FIG. 6, three space laser communication devices 500, 600, and 800 are illustrated. Each of the space laser communication devices 500, 600, and 800 may be configured with two optical systems. The space laser communication device 500 illustrated in a middle region of FIG. 6 may perform optical wireless communication with the space laser communication device 600, based on a full-duplex scheme, and may perform optical wireless communication with the space laser communication device 900, based on a relay scheme.

In operating of full-duplex space laser communication based on a 2×2 optical MIMO-relay scheme, in order to perform optical wireless communication based on a relay scheme, one optical system 100 of two optical systems 100 and 200 of the space laser communication device 500 may rotate and move toward two optical systems 300 and 400 configured in the other space laser communication device 600, based on control by a motion control device (50 of FIG. 1) (a PAT system), and the other one optical system 200 may rotate and move toward two optical systems 700 and 800 configured in the other space laser communication device 900, based on control by the motion control device (50 of FIG. 1) (the PAT system). In this case, an optical wireless communication link where SISO, single-input multi-output (SIMO), and multi-input single-output (MISO) are hybridized may be constructed. In a case where the space laser communication device 500 does not perform a relay function and performs space laser communication with one space laser communication device 600, the space laser communication device 500 may perform full-duplex optical MIMO communication.

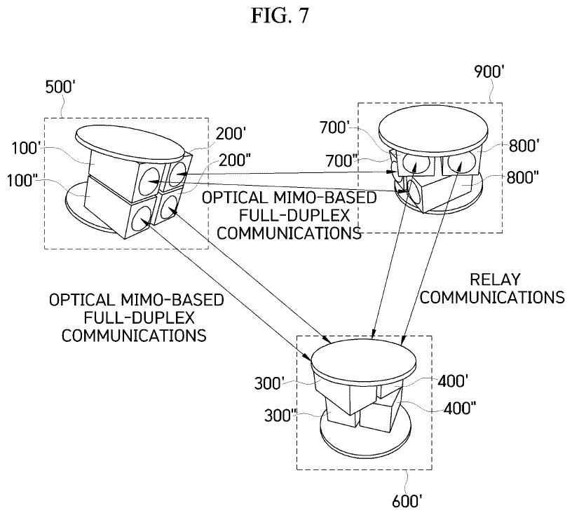

FIG. 7 is a diagram conceptually illustrating a management and operation of a full-duplex space laser communication device based on a 4×4 optical MIMO-relay scheme according to another embodiment of the present invention.

In FIG. 7, three space laser communication devices 500′, 600′, and 900′ are illustrated. Each of the space laser communication devices 500′, 600′, and 900′ may be configured with two upper optical systems disposed in an upper side and two lower optical systems disposed thereunder. Accordingly, each space laser communication device may be configured with four optical systems.

In FIG. 7, upper optical systems 100′ and 200′ and lower optical systems 100″ and 200″ of the space laser communication device 500′ illustrated in a left upper region may be optically aligned in the same direction, based on control by a motion control device (50 of FIG. 1) (a PAT system). In FIG. 7, upper optical systems 300′ and 400′ of the space laser communication device 600′ illustrated in a lower region may be optically aligned with the lower optical systems 100″ and 200″ of the space laser communication device 500′, based on control by the motion control device (50 of FIG. 1) (the PAT system), and lower optical systems 300″ and 400″ of the space laser communication device 600′ may be optically aligned with upper optical systems 700′ and 800′ of the space laser communication device 900′, based on control by the motion control device (50 of FIG. 1) (the PAT system). In FIG. 7, lower optical systems 700″ and 800″ of the space laser communication device 900′ illustrated in a left upper region may be optically aligned with the upper optical systems 100′ and 200′ of the space laser communication device 500′, based on control by the motion control device (50 of FIG. 1) (the PAT system).

Based on optical alignment control, the space laser communication device 500′ may perform optical MIMO-based full-duplex communication with each of the other space laser communication device 600′ and the other space laser communication device 900′. Also, the space laser communication device 600′ may perform relay communication with the space laser communication device 500′ via the other space laser communication device 900′. Such relay communication may be performed identically in all of the space laser communication device 500′, 600′, and 900′.

In a full-duplex space laser communication device based on a 4×4 optical MIMO-relay scheme, unlike the embodiment of FIG. 6, an optical wireless communication link having a triangular shape may be constructed. According to the embodiments of FIGS. 6 and 7, various devices may be simultaneously connected to each other, based on a multi-user (MU)-MIMO scheme, and thus, the efficiency of use of a network frequency may increase.

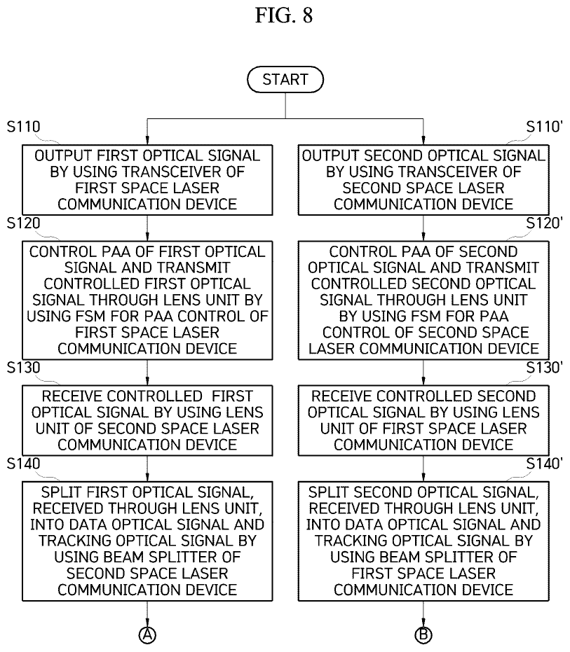

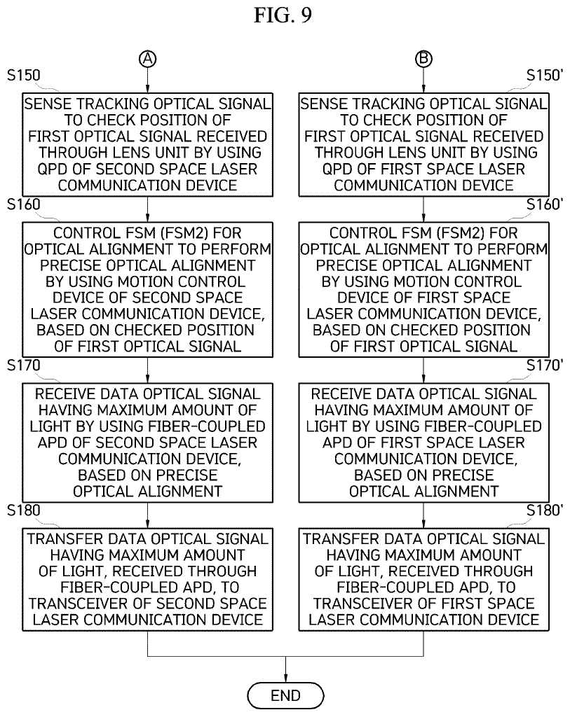

FIGS. 8 and 9 are diagrams for describing an operating method of a full-duplex space laser communication device based on an optical MIMO-relay scheme according to an embodiment of the present invention.

First, in FIG. 2, a communication environment may be assumed where a first space laser communication device 500 performs full-duplex communication for simultaneously performing transmission and reception in both directions with a second space laser communication device (600 of FIG. 2). Also, it may be assumed that two optical systems (100 and 200 of FIG. 2) included in the first space laser communication device (500 of FIG. 2) face different directions, and one optical system 100 of the two optical systems 100 and 200 performs optical MIMO-based full duplex communication with an optical system 300 of the second space laser communication device (600 of FIG. 2). Also, the following operating method may be applied in a communication environment illustrated in FIGS. 5 to 7.

Referring to FIGS. 8 and 9, in step S110, a transceiver (102 of FIG. 2) of the first space laser communication device 500 may output a first optical signal to a vertical section of a transmission optical fiber. Simultaneously, in step S110′, a transceiver (315 of FIG. 2) included in the optical Ethernet card of the second space laser communication device 600 may output a second optical signal to the vertical section of the transmission optical fiber.

Subsequently, in step S120, an FSM (104 of FIG. 2) (FSM1) for PAA control of the first space laser communication device 500 may control a PAA of the first optical signal and may transmit the controlled first optical signal through a lens unit (109 of FIG. 2). Simultaneously, in step S120′, an FSM (314 of FIG. 2) (FSM1) for PAA control of the second space laser communication device 600 may control a PAA of the second optical signal and may transmit the controlled second optical signal through a lens unit (304 of FIG. 2).

Subsequently, in step S130, the lens unit (304 of FIG. 2) of the second space laser communication device 600 may receive the controlled first optical signal. Simultaneously, in step S130′, the lens unit 109 of the first space laser communication device 500 may receive the controlled second optical signal.

Subsequently, in step S140, a beam splitter (308 of FIG. 2) of the second space laser communication device 600 may split the first optical signal, received through the lens unit (304 of FIG. 2), into a data optical signal and a tracking optical signal. Simultaneously, in step S140′, a beam splitter (112 of FIG. 2) of the first space laser communication device 500 may split the second optical signal, received through the lens unit 109, into a data optical signal and a tracking optical signal.

Subsequently, in step S150, a QPD (309 of FIG. 2) of the second space laser communication device 600 may sense the tracking optical signal to check a position of the first optical signal received through the lens unit (304 of FIG. 2). Simultaneously, in step S150′, a QPD (113 of FIG. 2) of the first space laser communication device 500 may sense the tracking optical signal to check a position of the first optical signal received through the lens unit 109.

Subsequently, in step S160, a motion control device (150 of FIG. 1) of the second space laser communication device 600 may control an FSM (307 of FIG. 2) (FSM2) for optical alignment, based on the checked position of the first optical signal, and may thus perform precise optical alignment. Simultaneously, in step S160′, a motion control device (111 of FIG. 1) of the first space laser communication device 500 may control an FSM (307 of FIG. 2) (FSM2) for optical alignment, based on the checked position of the first optical signal, and may thus perform precise optical alignment.

Subsequently, in step S170, a fiber-coupled APD (310 of FIG. 2) of the second space laser communication device 600 may receive the data optical signal having the maximum amount of light, based on the precise optical alignment. Simultaneously, in step S170′, a fiber-coupled APD (103 of FIG. 2) of the first space laser communication device 500 may receive the data optical signal having the maximum amount of light, based on the precise optical alignment.

Subsequently, in step S180, the data optical signal having the maximum amount of light received through the APD (310 of FIG. 2) may be transferred to a transceiver (315 of FIG. 2) of the second space laser communication device 600. Simultaneously, in step S180′, the data optical signal having the maximum amount of light received through the APD 103 may be transferred to a transceiver (102 of FIG. 2) of the first space laser communication device 500. Also, the APDs 103 and 310 may each be included in a transceiver (102 of FIG. 2), and in this case, steps S180 and S180′ may be omitted.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An operating method of a space laser communication device including at least two optical systems and a motion control device controlling motions of the at least two optical systems, the operating method comprising:
a step of performing optical alignment so that one of the at least two optical systems performs optical multiple input multiple output (MIMO)-based full-duplex communication with another space laser communication device, based on motion control by the motion control device; and
a step of performing optical alignment so that the other optical system of the at least two optical systems performs optical MIMO-based relay communication with another space laser communication device, based on motion control by the motion control device.

2. The operating method of claim 1, wherein the step of performing the optical alignment so that the one optical system performs the optical MIMO-based full-duplex communication with the other space laser communication device comprises:
a step of outputting an optical signal by using a transceiver of the space laser communication device;
a step of controlling a pointing ahead angle of the output optical signal by using a fast steering mirror of the space laser communication device; and
a step of transmitting the pointing ahead angle-controlled optical signal to the other space laser communication device by using a lens unit of the space laser communication device.

3. The operating method of claim 2, further comprising a step of performing 5-axis control of an optical fiber connector by using a 5-axis stage device of the space laser communication device to control a divergence angle of the optical signal output from the transceiver, between the step of outputting the optical signal and the step of controlling the pointing ahead angle of the optical signal.

4. The operating method of claim 1, wherein the step of performing the optical alignment so that the one optical system performs the optical MIMO-based full-duplex communication with the other space laser communication device comprises:
a step of receiving an optical signal from the other space laser communication device by using a lens unit of the space laser communication device;
a step of splitting the received optical signal into a data optical signal and a tracking optical signal by using a beam splitter of the space laser communication device;
a step of sensing the tracking optical signal by using a quadrant photodiode of the space laser communication device to check a position of the optical signal;
a step of performing the optical alignment by using a fast steering mirror of the space laser communication device, based on the checked position of the optical signal; and
a step of receiving the data optical signal having a maximum amount of light by using an avalanche photodiode of the space laser communication device, based on the performed optical alignment.

5. A space laser communication device comprising:
optical systems; and
a motion control device configured to control motions of the optical systems,
wherein one of the optical systems performs optical alignment to perform optical multiple input multiple output (MIMO)-based full-duplex communication with another space laser communication device disposed at a first position, based on motion control by the motion control device, and
the other optical system of the optical systems performs optical MIMO-based relay communication with another space laser communication device disposed at a second position differing from the first position, based on motion control by the motion control device.

6. The space laser communication device of claim 5, wherein each of the optical systems comprises:
a transceiver configured to output an optical signal;
a fast steering mirror configured to control a pointing ahead angle of the output optical signal; and
a lens unit configured to transmit the pointing ahead angle-controlled optical signal to the other space laser communication device.

7. The space laser communication device of claim 6, further comprising a 5-axis stage device configured to perform 5-axis control of an optical fiber connector to control a divergence angle of the optical signal output from the transceiver.

8. The space laser communication device of claim 5, wherein each of the optical systems comprises:
a lens unit of the space laser communication device configured to receive an optical signal from the other space laser communication device;
a beam splitter configured to split the received optical signal into a data optical signal and a tracking optical signal;
a quadrant photodiode configured to sense the tracking optical signal to check a position of the optical signal;
a fast steering mirror configured to perform the optical alignment, based on the checked position of the optical signal; and
an avalanche photodiode configured to receive the data optical signal having a maximum amount of light, based on the performed optical alignment.

9. The space laser communication device of claim 5, wherein the optical systems comprise two upper optical systems disposed in an upper side and two lower optical systems disposed in a lower side, and
the upper optical systems perform optical MIMO-based full-duplex communication with the other space laser communication device, and the lower optical systems perform optical MIMO-based relay communication with the other space laser communication device.

10. The space laser communication device of claim 9, wherein the upper optical systems rotate and move to face the other space laser communication device, based on control by the motion control device, and
the lower optical systems rotate and move to face the other space laser communication device, based on control by the motion control device.
